(19) United States
(12) Patent Application Publication
(10) Pub. No.: US 2023/0305295 A1
(43) Pub. Date: Sep. 28, 2023

(54) METHOD TO DESIGN OPTICAL SYSTEMS USING METALENS ELEMENTS FOR DISTORTION CONTROL

(71) Applicant: ImmerVision, Inc., Montreal (CA)

(72) Inventors: Simon THIBAULT, Quebec City (CA); Jocelyn PARENT, Lavaltrie (CA); Patrice ROULET, Montreal (CA); Zhenfeng ZHUANG, Montreal (CA); Raphael LAROUCHE, Montreal (CA); Pierre KONEN, Saint-Bruno (CA); Pascale NINI, Orford (CA)

(21) Appl. No.: 18/125,230

(22) Filed: Mar. 23, 2023

Related U.S. Application Data
(60) Provisional application No. 63/322,817, filed on Mar. 23, 2022.

(51) Int. Cl. G02B 27/00; G02B 1/00; B82Y 20/00

(52) U.S. Cl. CPC G02B 27/0068; G02B 1/002; B82Y 20/00

(57) ABSTRACT

In embodiments of optical systems with at least one metalens containing at least one metasurface, the addition of the at least one metalens element is used to modify by at least ±5% either the f*tan(θ) distortion, the f*θ distortion or the resolution of the designed optical system compared to a reference optical system without the metalens. The method presented using at least one metalens can be used as well for monochromatic as for polychromatic optical systems. The at least one metalens element can also be used, in addition to modifying the distortion or the resolution of the optical system, to modify at the same time other optical properties like the image quality. The metalens has at least one metasurface made of nano structure elements and their shape, size, position and orientation depend on the required optical properties of the metalens.

### CROSS-REFERENCE TO RELATED APPLICATIONS

This application claims the benefit of U.S. Provisional Patent Application No. 63/322,817, filed Mar. 23, 2022, entitled “Method to design optical systems using metalens elements for distortion control,” currently pending, the entire contents of which are incorporated by reference herein.

### BACKGROUND OF THE INVENTION

Embodiments of the present invention relate to the field of optical systems and their design and, more particularly, to the use of metalenses inside the optical systems in order to modify the optical distortion, magnification, or resolution of optical systems.

In order to control perfectly the optical distortion of an optical system, special care to the shape of optical elements is required. This is especially true for wide-angle lenses having fields of view over 80° in which the optical distortion becomes more challenging to control to a desired level with increasing fields of view because, in part, of the increasing optical aberrations present for off-axis fields in the field of view.

Furthermore, because of the high incidence angle often present on optical surfaces of wide-angle lens systems, having a specific distortion profile generally requires large optical elements which increase the overall dimension, the weight, and the cost of the optical system.

While the use of metalenses including at least one metasurface has already been proposed in order to change the direction of some rays of light in an optical system, including in the publication “Consumer electronic optics: how small a lens can be using metasurfaces,” Proc. SPIE 1110406 (2019), there has never been a method using a metalens element specially to counter the drawbacks of classical optical systems when trying to target a specific distortion or resolution profile.

### BRIEF SUMMARY OF THE INVENTION

Embodiments of the present invention describe a method to design an optical system using a metalens element in order to modify the distortion or the resolution function compared to a reference optical system without the metalens. The position of this at least one added metalens element can be anywhere in the optical system, but it is often far from the aperture stop (such as in front of all of the other elements of the reference optical system or near the image plane) since it is the best place to adjust the distortion or resolution function because the rays for different fields hit the surface in different regions.

According to embodiments of the method of the current invention, adding at least one metalens element in the optical system is used to adjust for at least one field angle position by at least ±5%: either the value for the f*tan(θ) distortion profile, the f*0 distortion profile, or a custom resolution function which is defined as the mathematical derivative of the image height vs field angle function with respect to the field angle variable. In some other embodiments, the method can be used to adjust the distortion profile for this at least one field angle position by at least ±10%, by ±20%, or even by ±50%.

The at least one metalens used to modify the distortion or resolution according to embodiments of the present invention can be made of any material. In order to change the direction of rays of light passing through the metalens, it may include multiple nano-structures (e.g., meta-atoms) of any shape, size, position and direction to alter the electromagnetic fields surrounding them, thus changing the direction of rays passing through it. The structures can be made of any material, including, but in no way limited to, titanium dioxide (TiO2) or amorphous silicon (a-Si) structures or the like.

The optical system with metalens according to embodiments of the present invention can be used with any part of the light spectrum, including, but in no way limited to, at least a part of the visible and/or a part of the infra-red (IR) spectrum. The optical system can be monochromatic or polychromatic, using any width of the light spectrum from narrow band to wide band of the spectrum.

In some alternate embodiments according to the present invention, the at least one added metalens to the optical system is used to improve at least one other optical parameter in addition to modifying the distortion or resolution functions compared to the reference optical system. This improved optical parameter can be, for example, and in no way limiting the scope of the present invention, the image quality, the size (length or diameter), the incidence angle on any surface, the chief-ray angle at the image plane, the sensitivity to some manufacturing tolerances, the absolute transmission, the thermal stability when changing the temperature of the lens, the relative illumination of the optical system, or any other optical parameter.

In some alternate embodiments according to the present invention, instead of adding at least one metalens compared to the reference optical system, the method is used to replace at least one optical element from the reference optical system by a metalens in order to at least modify the distortion or the resolution function of the optical system. This at least one metalens used to replace at least one optical element compared to the reference optical system can also be optionally used to reduce the overall size of the optical system, allowing, for example, to reduce the overall total track length of the optical system by at least 10%. In some other embodiments, the optical system with metalens can be at least 20%, 30%, 40% or even 50% thinner than the optical total track length of the reference optical system.

In some alternate embodiments according to the present invention, the at least one added metalens to the optical system is used to improve the chief ray angle (CRA), in addition to modifying the distortion or resolution functions compared to the reference optical system. This improved optical parameter can be, for example, and in no way limiting the scope of the present invention, to match the sensor CRA requirement.

In some alternate embodiments according to the present invention, the at least one added metalens to the optical system is used to separate the polarization of the light in addition to modifying the distortion or resolution functions compared to the reference optical system. This improved optical parameter can be used, for example, and in no way limiting the scope of the present invention, to discriminate man-made objects from nature in a scene.

In some alternate embodiments according to the present invention, the at least one added metalens to the optical system is used to separate the spectral (color) of the light in addition to modifying the distortion or resolution functions compared to the reference optical system. This improved optical parameter can be, for example, and in no way limiting the scope of the present invention, to analyze various spectral components of the scene for diagnosis in medical, food or agriculture industries.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustration, there is shown in the drawings an embodiment which is presently preferred. It should be understood, however, that the invention is not limited to the precise arrangements and instrumentalities shown.

In the drawings:

FIG. 1A shows image creation using a reference optical system;

FIG. 1B shows image creation and controlling the distortion of an optical system using at least one metalens element;

FIG. 2A shows an example of a reference optical system;

FIG. 2B shows an example embodiment of the method to use a metalens in an optical system to control the distortion or the resolution;

FIG. 3A shows the f*tan(θ) distortion graph for the example embodiment before adding the metalens element;

FIG. 3B shows the f*tan(θ) distortion graph for the example embodiment after adding the metalens element;

FIG. 4A shows the resolution function graph for the reference optical system;

FIG. 4B shows the resolution function graph for the optical system with metalens; and

FIG. 5 shows an example of a metalens according to an embodiment of the present invention.

### DETAILED DESCRIPTION OF THE INVENTION

The words “a” and “an”, as used in the claims and in the corresponding portions of the specification, mean “at least one.”

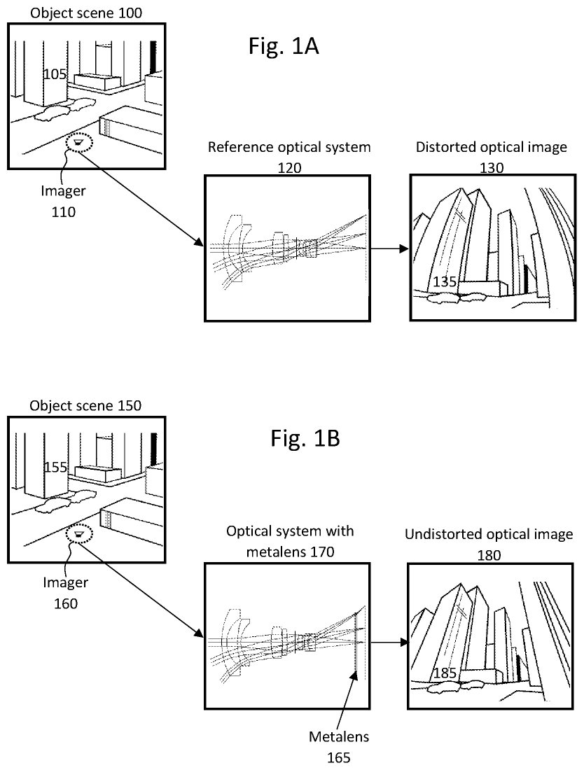

FIGS. 1A and 1B show the overall method to control the distortion of an optical system using at least one metalens element. The classical approach is shown at FIG. 1A, while the approach according to an embodiment of the present invention is shown at FIG. 1B. For the classical approach to design a reference optical system, there is an object scene 100 that is viewed by an imager 110. In the example of FIG. 1A, the object scene represents a city scene with some buildings, roads, and cars, but this is just an example and the object scene could be anything according to embodiments of the present invention. In the object scene 100, the buildings 105 are made of straight lines as they are in the real world. The imager 110 may be any device configured to create a reference optical image of the object scene using an optical system and to convert the optical image created in a reference image plane to a digital image file using an image sensor located generally at this image plane. In the example of FIG. 1A, the optical system is the reference optical system 120 including an imaging lens made of multiple refracting lens elements, but the optical system could be anything according to embodiments of the present invention, including an optical system made of any number of refracting, reflecting, or diffracting optical elements. In the example of FIG. 1A, the reference optical system 120 creates a potentially distorted optical image 130, as seen, for example, by the curved lines on the building 135.

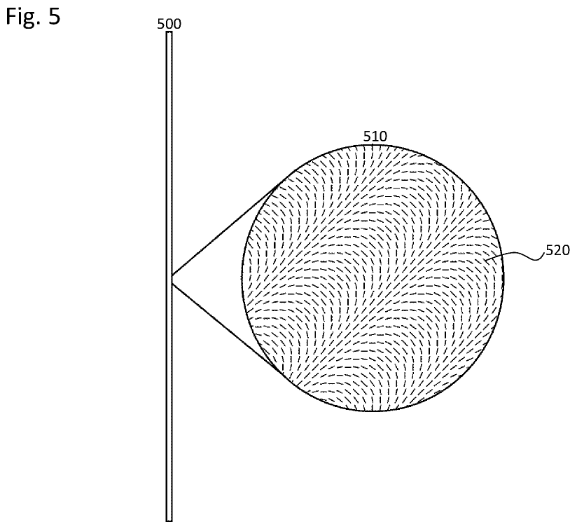

In the example of FIG. 1B showing an embodiment of the method according to the present invention to have a designed optical system, the object scene 150 is the same as the previous object scene 100 from FIG. 1A, again including buildings, roads, and cars. The building 155 is made of straight lines in the object scene as they are in the real world. The imager 160 again may be any device configured to create an optical image of the object scene using an optical system and to convert the optical image created in an image plane to a digital image file using an image sensor located generally at this image plane. But in the example of FIG. 1B, the designed optical system is a designed optical system with metalens 170, including the reference optical system 120 and at least one metalens 165 added. A metalens is any optical element having at least one metasurface as will be explained in more detail at FIG. 5. The metalens 165 is used to change the direction of the rays from the optical systems in order to control the optical distortion. In the example of FIG. 1B, the resulting image is an undistorted optical image 180 having no f*tan(θ) optical distortion, as seen by the straight lines in the image 180 for the building 185.

However, this complete removal of the optical distortion is just an example of controlled distortion according to an embodiment of the present invention. The metalens 165 can be used to control the optical distortion to any desired shape or projection, including controlling the f*tan(θ) distortion under or above a target value, controlling the f*θ distortion under or above a target value, targeting a desired custom distortion profile, creating a zone of interest in the image with higher magnification, resolution or distortion or the like. The method according to embodiments of the present invention uses at least one metalens in the optical system in order to control, correct, or modify, at least partially, optical distortion by affecting the distribution function, that is the mathematical function linking the object scene angle and the corresponding image height for a given chief-ray of light. The chief-ray for a given field angle is the ray passing through the middle of the aperture stop for this given field angle. In some embodiments according to the present invention, there is a difference of at least ±5% in f*tan(θ) distortion for at least one field inside the image between the reference optical system without the metalens and the designed optical system with the metalens. This value of at least ±5% is a good threshold value according to the method of the present invention with which the distortion is modified on-purpose as opposed to an accidental small change of distortion below ±5% when adding a metalens without the concept of the present invention. In some other embodiments, the method can be used to adjust the f*tan(θ) distortion profile for this at least one field angle position by at least ±10%, by ±20%, by 30%, by 40% or even by ±50%. In some other embodiments according to the present invention, there is a difference of at least ±5% in f*θ distortion for at least one field inside the image between the reference optical system without metalens and the designed optical system with metalens. This value of at least ±5% is a good threshold value according to the embodiments of the method of the present invention with which the distortion is modified on-purpose as opposed to an accidental small change of distortion below ±5% when adding a metalens without the concept of the present invention. In some other embodiments, the method can be used to adjust the f*θ distortion profile for this at least one field angle position by at least ±10%, by ±20%, by 30%, by 40% or even by ±50%. In some other embodiments according to the present invention, there is a difference of at least ±5% in the resolution, measured for example in pixels/° or μm/°, for at least one field inside the image between the reference optical system without metalens and the designed optical system with metalens. This value of at least ±5% is a good threshold value according to embodiments of the method of the present invention with which the resolution is modified on-purpose as opposed to an accidental small change of resolution below ±5% when adding a metalens without the concept of the present invention. In some other embodiments, the method can be used to modify the value of the resolution function for this at least one field angle position by at least ±10%, by ±20%, by 30%, by 40% or even by ±50%.

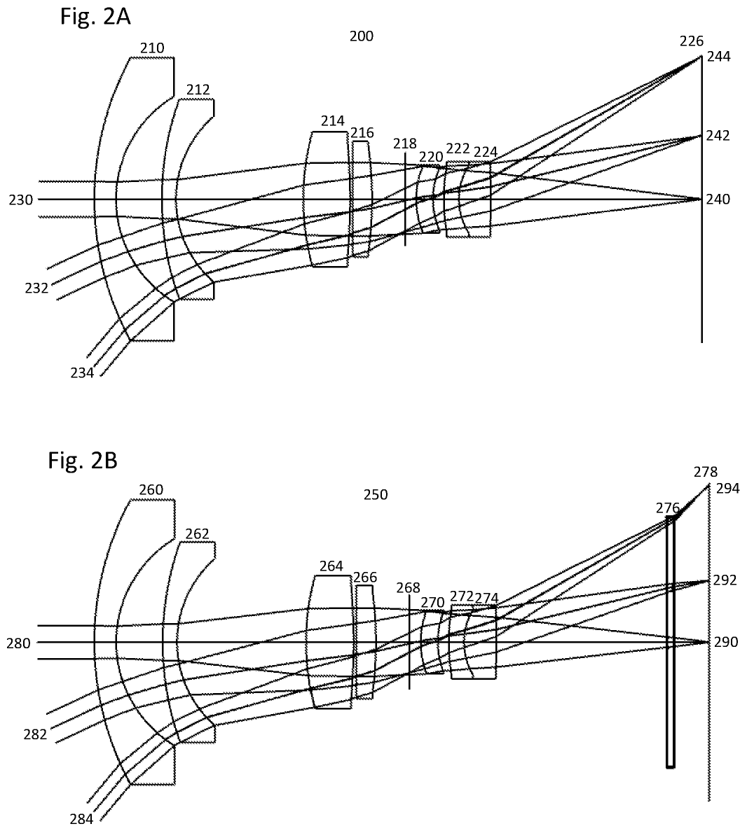

FIGS. 2A and 2B show one example embodiment of the method to use a metalens in an optical system to control the distortion or the resolution. At FIG. 2A, the reference optical system without metalens 200 is shown. In this example, the optical system includes seven classical optical elements 210, 212, 214, 216, 220, 222, and 224 as well as an aperture stop 218. This is just an example reference optical system 200, but the method according to embodiments of the present invention is not limited to any number of or any type of classical optical elements. For example, in some embodiments, the reference optical system 200 could be a single lens element creating an image in an image plane to which the added metalens is used to control the distortion of the combined system. Any of the classical optical elements could be refractive, reflective, diffractive, or the like. In this example reference optical system without metalens 200, the reference total field of view of the lens is 100°, but the method according to embodiments of the present invention is not limited to any value of reference field of view and could be used with reference systems having fields of view smaller than 5° up to fields of view even larger than 300°. The optical elements in the reference optical system without metalens 200 could be made from any optical material, including glass, plastics, crystal or any other material able to transmit, reflect, refract, or diffract the light. The reference focal length of this reference design is 0.5 mm, but this is just an example and the focal length could be of any value according to embodiments of the present invention. The rays 230 are coming from a field angle of 0° and hit the reference image plane 226 at position 240, having an image height of 0 mm. The rays 232 are coming from a field angle of 25° and hit the reference image plane 226 at position 242, having an image height of 0.225 mm. The rays 234 are coming from a field angle of 50° and hit the reference image plane 226 at position 244, having an image height of 0.507 mm. In a preferred embodiment according to the present invention, the reference and modified image height on the image plane 226 is measured using the chief-ray for that field angle, that is the ray that passes through the center of the aperture stop. In alternate embodiments, the reference and modified image height can also be measured using the location of the centroid of the spot size created by this field angle. All of these ray angles and corresponding image heights from FIG. 2A are just examples in order to explain the method according to embodiments of the present invention and the method according to embodiments of the present invention is in no way limited to these ray angles or these image heights.

FIG. 2B shows the designed optical system with metalens 250 designed according to an embodiment of the method of the present invention. This optical system 250 includes the reference optical system 200 and at least one metalens element 276 as will be explained in more detail at FIG. 5. In this example, the metalens element 276 is located close to the image plane 278 and after the seven optical elements 260, 262, 264, 266, 270, 272 and 274 and the aperture stop 268. However, this is just an example and in other embodiments the at least one metalens 276 could be located in front of all other optical elements (as for example on a protection cover for a lens), in between any number of optical elements or close to the image plane as in FIG. 2B. The metalens 276 could also act as a filter in the system to filter UV light, IR light or any other undesirable part of the light spectrum. The metalens 276 could also act as a sensor coverglass to protect the image sensor from damage. In other embodiments according to the present invention, there could be two metasurfaces on the two surfaces of a single metalens element or there could be more than one metalens, for example, but in no way limiting the scope of the present invention, there could be a first metalens in front of the other optical elements and a second after the other optical elements. No matter the number or the positions, the metalens according to embodiments of the present invention is used at least to control the distortion in such a way that the modified distortion of the optical system with metalens 250 is different than the distortion of the reference optical system 200. In this example, the metalens 276 keeps the modified total field of view of 100° and adjusts the resulting image height, but the control of the distortion could also be done by changing the field of view for a fixed image height or a mix of both. The modified total field of view of the optical system with metalens 250 can thus be either identical to or different than the reference total field of view of the reference optical system 200. The modified focal length of this optical system with metalens is 0.462 mm, but this is just an example and the focal length could be of any value according to embodiments of the present invention. In this example, the modified focal length of the optical system with metalens 250 is different than the reference focal length of the reference system 200 in order to control the distortion, but the reference focal length and the modified focal length could be identical in other embodiments. The rays 280 are coming from a field angle of 0° and hit the modified image plane 278 at position 290, having an image height of 0 mm. The rays 282 are coming from a field angle of 25° and hit the modified image plane 278 at position 292, having an image height of 0.216 mm. The rays 284 are coming from a field angle of 50° and hit the modified image plane 278 at position 294, having an image height of 0.551 mm. The reference image plane of the reference optical system and the modified image plane of the modified optical system could either be identical or different according to the present invention. The reference image plane and the modified image plane are generally straight, but either or even both could also be curved according to embodiments of the present invention.

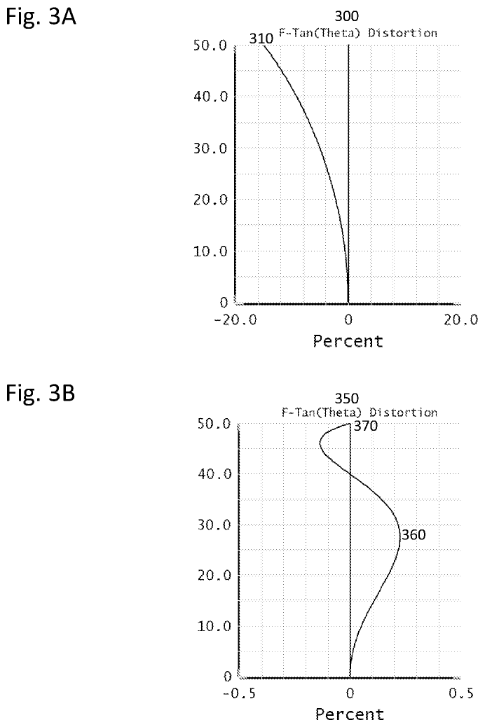

FIGS. 3A and 3B show the f*tan(θ) distortion graphs for the example systems of FIGS. 2A and 2B. The graph 300 at FIG. 3A is for the reference optical system 200 while the graph 350 at FIG. 3B is for the designed optical system with metalens 250. In this example, the reference optical system has a reference focal length of 0.5 mm and the ideal f*tan(θ) image height at a field angle of 50° would be 0.5*tan)(50°=0.596 mm. For rays from 50°, the real image height of 0.507 mm corresponds to an f*tan(θ) distortion of −15% (0.507-0.596)/0.596 as seen on the graph at position 310. Also in this example, the designed optical system with metalens has, in FIG. 3B, a lower modified focal length of 0.462 mm and the ideal f*tan(θ) image height at a field angle of 50° would be 0.462*tan)(50°=0.551 mm. For rays from 50°, the real image height of 0.551 mm corresponds to an f*tan(θ) distortion of 0% (0.551-0.551)/0.551 as seen on the graph at position 370. The graph of f*tan(θ) 350 in FIG. 3B shows that for other fields of view, the distortion remains under 0.25%, with the maximum value seen at position 360. In some embodiments according to the present invention, there is a difference of at least ±5% in f*tan(θ) distortion for at least one field inside the image between the reference optical system without metalens and the optical system with metalens. This value of at least ±5% is a good threshold value according to embodiments of the method of the present invention with which the distortion is modified on-purpose as opposed to an accidental small change of distortion below ±5% when adding a metalens without the concept of the present invention. The example of FIGS. 3A and 3B shows that for the field of view at 50°, the f*tan(θ) distortion changed from −15% to 0% when adding the metalens element, which is a change of f*tan(θ) distortion indeed above the ±5% according to embodiments of the method of the present invention.

In some other embodiments, the method can be used to adjust the f*tan(θ) distortion profile for this at least one field angle position by at least ±10%, by ±20%, by 30%, by 40% or even by ±50% or more. In some other embodiments according to the present invention, the addition of at least one metalens to the optical system creates instead a difference of at least ±5% in f*0 distortion for at least one field inside the image between the reference optical system without metalens and the optical system with metalens. This value of at least ±5% is a good threshold value according to embodiments of the method of the present invention with which the distortion is modified on-purpose as opposed to an accidental small change of distortion below ±5% when adding a metalens without the concept of the present invention. In some other embodiments, the method can be used to adjust the f*0 distortion profile for this at least one field angle position by at least ±10%, by ±20%, by 30%, by 40% or even by ±50%. Furthermore, in the example of FIGS. 3A and 3B, the f*tan(θ) distortion is well corrected everywhere in the field of view (<0.25%) after adding at least one metalens to the optical system, but this is just an example and the distortion control according to embodiments of the present invention could partially correct the distortion without being close to 0% at any of the fields or it could even be used to increase the distortion instead of reducing it, if required. The modification of the distortion according to embodiments of the present invention can be over the whole field of view at the same time or only in a localized region of the field of view, for example to create a localized zone of interest in a part of the image. This localized region or interest can be symmetrical or not with respect to the optical axis. In summary, the difference between a modified resolution function and a reference resolution function creates at least a difference of ±5% in either an f*θ or an f*tan(θ) distortion for at least one field angle inside the reference and modified total fields of view, but this ±5% value can be higher in other embodiments.

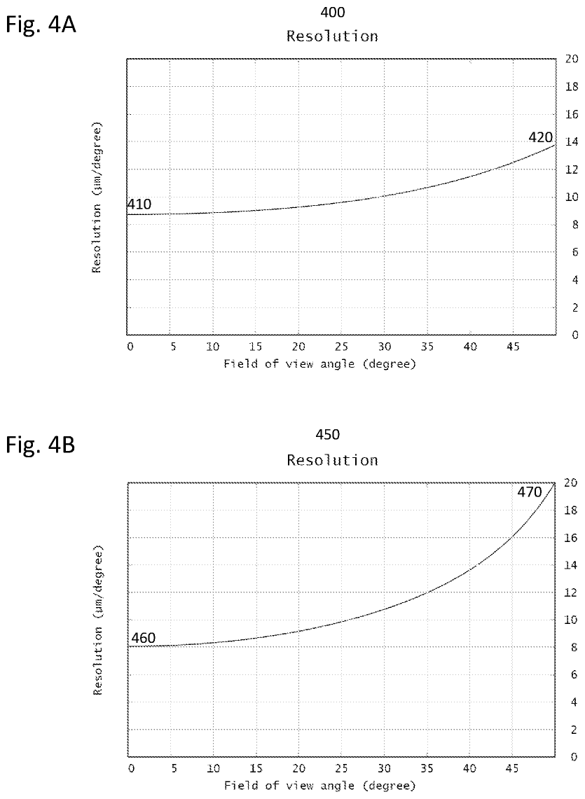

FIGS. 4A and 4B show the resolution function graphs for the example system of FIGS. 2A and 2B. The reference resolution function graph 400 for the reference optical system is at FIG. 4A and the modified resolution function graph 450 for the optical system with metalens is at FIG. 4B. The resolution function is the mathematical derivative of the distribution function with respect to the field angle. The distribution function is the mathematical function linking the object scene angle and the corresponding image height for a given ray of light. The image height for a given field is generally calculated as the height of the chief-ray on the image plane for a theoretical optical system inside an optical design software or using the height of the centroid for a built optical system. In the resolution graph 400 for the reference optical system, the value 410 for the resolution at a field angle of 0° is 8.7 μm/° while the value 420 for the resolution at a field angle of 50° is 13.8 μm/°. In the resolution graph 450 for the optical system with metalens, the value 460 for the resolution at a field angle of 0° is 8.1 μm/° while the value 470 for the resolution at a field angle of 50° is 19.9 μm/°. For the edge field of view of 50°, the resolution increased from 13.8 μm/° to 19.9 μm/° by adding the metalens to the optical system, an increase of (19.9-13.8)/13.8=44%. In some embodiments according to the present invention, there is a difference of at least ±5% between the modified resolution function and the reference resolution function, measured for example in pixels/° or inn/°, for at least one field inside the image between the reference optical system without metalens and the designed optical system with metalens. This value of at least ±5% is a good threshold value according to embodiments of the method of the present invention with which the resolution is modified on-purpose as opposed to an accidental small change of resolution below ±5% when adding a metalens without the concept of the present invention. In the example from FIGS. 4A and 4B, the increase of 44% in resolution is indeed above the ±5% change according to embodiments of the method of the current invention. This change can be in the positive or negative direction, meaning an increase or a decrease of pixels/° using the metalens. In some other embodiments, the method can be used to modify the value of the resolution function for this at least one field angle position by at least ±10%, by ±20%, 30%, 40% or even by ±50%.

FIG. 5 shows an example of a metalens according to an embodiment of the present invention. In this example, the metalens 500 is a window with both main surfaces being flat and in which at least one surface called a metasurface has nano structure elements (e.g., meta-atoms) in order to modify the electrical and magnetic fields around them, thus affecting the direction of light passing through the surface. In some other embodiments according to the present invention, the metasurface could be applied on a surface with a curvature instead of being flat, for example a spherical surface, a conical surface, an aspherical surface or a freeform surface. In FIG. 5, the enlarged view 510 show an example of how the metasurface could appear at the microscopic level. The metasurface may be made of multiple meta-atoms like cylindrical nanorods or nanofins 520. This cylindrical structure is just an example, but the meta-atoms could be of any shape, including rectangular prisms, cubic, spherical or in the shape of any complex volume required in order to affect the electrical and magnetic fields as required. The material for these microstructures of the at least one metalens element according to embodiments of the present invention could be of any type, as for example, and in no way limiting the scope of the present invention, structures made of titanium dioxide (TiO2) or amorphous silicon (a-Si) structures, or the like. The distance between each microstructure, their length, height and width dimensions, their orientations or any other parameter affecting their optical properties is calculated for each position on the metasurface in order to create the required phase differences in the fields to orient the incoming rays of light in the desired outgoing direction after passing through the surfaces. In order to calculate the exact parameters of the metalens to control the optical distortion of the optical system as desired, optimization is done either with some mathematical models, with numerical simulations software including finite element analysis software or the like. In some embodiments according to the present invention, the metalens 500 is symmetrical with respect to at least one main axis. This symmetry can be rotational symmetry around the optical axis or around any other axis. This symmetry can also be with respect to any plane passing through the metalens, including the X or the Y plane. In other embodiments, the metalens 500 could be completely without any symmetrical feature.

In summary, embodiments of the method according to the present invention are used to design an optical system using at least one metalens element for distortion control. The first step of the method may be designing a reference optical system with at least one classical optical element arranged along an optical axis, the designed reference optical system being configured to create a reference optical image in a reference image plane, the reference optical image having a reference total field of view in which is defined a reference resolution function. The second step of the method may be adding at least one metalens element into the reference optical system design along the optical axis to create a designed optical system, the designed optical system being configured to create a modified optical image in a modified image plane, the modified optical image having a modified total field of view in which is defined a modified resolution function. The third step of the method may be building the designed optical system. In this method, a value of the modified resolution function may be at least ±5% from a corresponding value of the reference resolution function for at least one common field angle inside the reference and modified total fields of view.

An alternate method according to an embodiment of the present invention is used to design an optical system using at least one metalens element for distortion control. The first step of this alternate method may be designing a reference optical system with two or more classical optical elements arranged along an optical axis, the designed reference optical system being configured to create a reference optical image in a reference image plane, the reference optical image having a reference total field of view in which is defined a reference resolution function. The second step of this alternate method may be replacing at least one of the two or more classical optical elements in the designed reference optical system with at least one metalens element arranged along the optical axis to create a designed optical system, the designed optical system being configured to create a modified optical image in a modified image plane, the modified optical image having a modified total field of view in which is defined a modified resolution function. The third step of this alternate method may be building the designed optical system. In this alternate method, a value of the modified resolution function may be at least ±5% from a corresponding value of the reference resolution function for at least one common field angle inside the reference and modified total fields of view.

In addition to the methods, the invention may also include an optical system using at least one metalens element for distortion control. The optical system first includes a reference optical system with at least one classical optical element arranged along an optical axis, the reference optical system creating a reference optical image in a reference image plane, the reference optical image having a reference total field of view in which is defined a reference resolution function. The optical system also includes at least one metalens element arranged along the optical axis, the optical system creating a modified optical image in a modified image plane, the modified optical image having a modified total field of view in which is defined a modified resolution function. In the system, a value of the modified resolution function may be at least ±5% from a corresponding value of the reference resolution function for at least one common field angle inside the reference and modified total fields of view.

In some embodiments according to the present invention, the optical system is configured to operate only in the full visible spectrum (400 nm to 700 nm) or only in a smaller sub-part of the visible spectrum. In some other embodiments, the optical system may be designed to operate in at least part of the visible spectrum and/or at least part of the infrared (IR) spectrum. The optical systems designed according to the methods to the present invention can thus be configured to operate on light in at least a part of the visible or the infrared spectrum. In some other embodiments, the method according to the present invention can be used to design monochromatic optical systems instead of polychromatic. In these systems, the design is optimized for either a single wavelength and a filter is then generally used to only let this particular wavelength or a narrow band around a central wavelength to pass through the optical system. In some embodiment, this narrow band of the electromagnetic spectrum is smaller than 10 nanometers, the limits of the narrow waveband being defined as the wavelengths where the transmission of the system due to its filter is 50%. In other embodiments, this narrow band can be smaller than 25 nanometers. In some other embodiments, this narrow band can be smaller than 50 nanometers. In some other embodiments, this narrow band can be smaller than 100 nanometers. The optical systems designed according to embodiments of methods to the present invention can thus be configured to operate on light either at a monochromatic wavelength or in a narrow wave band around a monochromatic wavelength.

In some alternate embodiments according to the present invention, the at least one added metalens to the optical system is used to modify at least one optical parameter of the reference optical system different from the reference resolution function, generally in order to improve this optical parameter. This modified optical parameter can be for example, and in no way limiting the scope of the present invention, the image quality, the size (length or diameter), the incidence angle on any surface, the chief-ray angle at the image plane, the sensitivity to some manufacturing tolerances, the absolute transmission, the thermal stability when changing the temperature of the lens, the relative illumination of the optical system or any other optical parameter.

In some other embodiments according to the present invention, the at least one metasurface element is used to also modify an optical parameter like to correct at least partially the optical aberrations of the optical system in addition to modifying the optical distortion. In these embodiments, when adding the at least one metalens element, the image quality (generally measured at an MTF percentage, but alternatively as the spot size or other methods), in at least one position of the image, is improved compared to the image quality of the system without the metalens element in addition to the modification to the distortion or the resolution caused by the metalens element. In some embodiments, this improvement of the image quality can be due in part to a correction of the field curvature using the at least one metalens element. This at least one position where the image quality is improved can be the same or can be different that the at least one field of view where a change of at least ±5% to the distortion function or of at least ±5% to the resolution function is achieved.

In some other embodiments according to the present invention, instead of adding at least one metalens compared to the reference optical system, the at least one metalens is used to replace at least one optical element from the reference system. In this specific embodiment, the at least one metalens that replaces at least one optical element is still used to modify the distortion function or the resolution function of the optical system compared to the reference optical system, but is also often used to reduce the overall size of the optical system since the metalens is generally thinner than the at least one optical element it replaced. This replaced optical element can be anywhere in the optical system and not necessarily at the position where this metalens used to replace it is inserted.

In some embodiments, the optical total track length of the optical system with metalens is at least 10% thinner than the optical total track length of the reference optical system. This is one example of the various other optical parameters that can also be modified when adding the metalens. In some other embodiments, the optical system with metalens is at least 20%, 30%, 40% or even 50% thinner than the optical total track length of the reference optical system. In some other embodiment, the addition of the metalens element can be used to modify the optical parameter of the diameter of at least some other optical elements.

In some other embodiments, in addition to being used to control the distortion or the resolution of an optical system, the metalens is used to reduce or increase the angle of incidence on a surface. This change to this optical parameter can be used for example, and in no way limiting the scope of the present invention, to increase the relative illumination of the optical system.

In some alternate embodiments according to the present invention, the at least one added metalens to the optical system is used to modify the chief ray angle (CRA) at the image plane in addition to modifying the distortion or resolution functions compared to the reference optical system. This improved optical parameter can be for example, and in no way limiting the scope of the present invention, to better match a sensor CRA departure requirement by having an optical system with metalens with a CRA curve similar to the CRA curve of the sensor.

In some alternate embodiments according to the present invention, the at least one added metalens to the optical system is used to separate the polarization of the light in addition to modifying the distortion or resolution functions compared to the reference optical system. This improved optical parameter can be used for example, in no way limiting the scope of the present invention, to discriminate man-made object from nature in a scene.

In some other embodiments, the reference optical system and the designed optical system are projection systems instead of imaging systems. In that case, the reference image plane and the modified image plane are located in the scene around the optical system instead of close to an image sensor. The reference field of view and the modified field of view are then in the projecting space around the optical system and the image height used to define the distortion or the resolution function is then the height on the projecting source (generally a display). The method according to such embodiments of the present invention is then still used to modify by at least ±5% either the modified distortion compared to a reference distortion or the modified resolution function compared to a reference resolution function for at least one common field angle inside the reference and modified total fields of view. This projecting optical system can be used to project anything, including an image, structured light, a pattern from a laser, a signal from a time-of-flight or a lidar system or the like.

In some alternate embodiments according to the present invention, the at least one added metalens to the optical system is used to separate the spectral (color) of the light in addition to modifying the distortion or resolution functions compared to the reference optical system. This improved optical parameter can be for example, and in no way limiting the scope of the present invention, to analyze various spectral components of the scene for diagnosis in medical, food or agriculture industries.

In some alternate embodiments according to the present invention, the reference optical system could already include at least one metalens element used for another reason than distortion control in addition to at least one classical optical element. The method according to embodiments of the present invention is then used to add at least one other metalens optical element and modify the distortion or the resolution function of the reference optical system to a modified distortion or modified resolution function that is different by at least ±5% for at least one field angle inside the total field of view.

In some alternate embodiments according to the present invention, the metalens added to create at least one metalens element in the modified optical system could be done by adding one metasurface on an already existing optical surface on one of the at least one classical optical element of the reference optical system instead of requiring to add a new optical element in the system. In this alternate embodiment, this classical optical element that is modified to a metalens element by adding a metasurface to at least one of its surfaces would still be used to modify the distortion or the resolution function of the reference optical system to a modified distortion or modified resolution function that is different by at least ±5% for at least one field angle inside the total field of view. In that case, the reference optical system uses the shape of the surface that is transformed to a metasurface as if there was no metasurface added it and the reference is calculated using the classical laws of optics.

All of the above are figures and examples showing embodiments of methods to design optical systems with at least one metalens element to control the distortion. These examples are not intended to be an exhaustive list or to limit the scope and spirit of the present invention. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method to design an optical system using at least one metalens element for distortion control, the method comprising:
a. designing a reference optical system with at least one classical optical element arranged along an optical axis, the designed reference optical system being configured to create a reference optical image in a reference image plane, the reference optical image having a reference total field of view in which is defined a reference resolution function,
b. adding at least one metalens element into the reference optical system design along the optical axis to create a designed optical system, the designed optical system being configured to create a modified optical image in a modified image plane, the modified optical image having a modified total field of view in which is defined a modified resolution function; and
c. building the designed optical system,
wherein a value of the modified resolution function is at least ±5% from a corresponding value of the reference resolution function for at least one common field angle inside the reference and modified total fields of view.

2. The method of claim 1, wherein the at least one metalens element is made of either titanium dioxide or amorphous silicon.

3. The method of claim 1, wherein the optical system is configured to operate on light in at least a part of the visible or the infrared spectrum.

4. The method of claim 1, wherein the optical system is configured to operate on light either at a monochromatic wavelength or in a narrow wave band around a monochromatic wavelength.

5. The method of claim 1, wherein the difference between the modified resolution function and the reference resolution function creates at least a difference of ±5% in either an f*theta or an f*tan(theta) distortion for at least one field angle inside the reference and modified total fields of view.

6. The method of claim 1, wherein the at least one metalens element modifies at least one optical parameter of the reference optical system different from the reference resolution function.

7. The method of claim 1, wherein the reference image plane is different from the modified image plane, and/or the reference field of view is different from the modified field of view.

8. A method to design an optical system using at least one metalens element for distortion control, the method comprising:
a. designing a reference optical system with two or more classical optical elements arranged along an optical axis, the designed reference optical system being configured to create a reference optical image in a reference image plane, the reference optical image having a reference total field of view in which is defined a reference resolution function,
b. replacing at least one of the two or more classical optical elements in the designed reference optical system with at least one metalens element arranged along the optical axis to create a designed optical system, the designed optical system being configured to create a modified optical image in a modified image plane, the modified optical image having a modified total field of view in which is defined a modified resolution function; and
c. building the designed optical system,
wherein a value of the modified resolution function is at least ±5% from a corresponding value of the reference resolution function for at least one common field angle inside the reference and modified total fields of view.

9. The method of claim 8, wherein the at least one metalens element is made of either titanium dioxide or amorphous silicon.

10. The method of claim 8, wherein the optical system is configured to operate on light in at least a part of the visible or the infrared spectrum.

11. The method of claim 8, wherein the optical system is configured to operate either at a monochromatic wavelength or in a narrow wave band around a monochromatic wavelength.

12. The method of claim 8, wherein the difference between the modified resolution function and the reference resolution function creates at least a difference of ±5% in either an f*theta or an f*tan(theta) distortion for at least one field angle inside the reference and modified total fields of view.

13. The method of claim 8, wherein the at least one metalens element modifies at least one optical parameter of the reference optical system different from the reference resolution function.

14. The method of claim 8, wherein the reference image plane is different from the modified image plane, and/or the reference field of view is different from the modified field of view.

15. An optical system using at least one metalens element for distortion control, the optical system comprising:
a. a reference optical system with at least one classical optical element arranged along an optical axis, the reference optical system creating a reference optical image in a reference image plane, the reference optical image having a reference total field of view in which is defined a reference resolution function; and
b. at least one metalens element arranged along the optical axis, the optical system creating a modified optical image in a modified image plane, the modified optical image having a modified total field of view in which is defined a modified resolution function,
wherein a value of the modified resolution function is at least ±5% from a corresponding value of the reference resolution function for at least one common field angle inside the reference and modified total fields of view.

16. The optical system of claim 15, wherein the at least one metalens element is made of either titanium dioxide or amorphous silicon.

17. The optical system of claim 15, wherein the optical system is configured to operate on light in at least a part of the visible or the infrared spectrum.

18. The optical system of claim 15, wherein the optical system is configured to operate on light either at a monochromatic wavelength or in a narrow wave band around a monochromatic wavelength.

19. The optical system of claim 15, wherein the difference between the modified resolution function and the reference resolution function creates at least a difference of ±5% in either an f*theta or an f*tan(theta) distortion for at least one field angle inside the reference and modified total fields of view.

20. The optical system of claim 15, wherein the at least one metalens element modifies at least one optical parameter of the reference optical system different from the reference resolution function.

21. The method of claim 15, wherein the reference image plane is different from the modified image plane, and/or the reference field of view is different from the modified field of view.
